(19) United States
(12) Patent Application Publication
(10) Pub. No.: US 2004/0241290 A1
(43) Pub. Date: Dec. 2, 2004

(54) Multi-layer packaging material with carbon dioxide scavenger, processes, and packaged food products

(76) Inventor: Ali El-Afandi, Maplewood, MN (US)

Correspondence Address: KAGAN BINDER, PLLC, Maple Island Building, Suite 200, 221 Main Street North, Stillwater, MN, 55082, US

(21) Appl. No.: 10/446,482

(22) Filed: May 28, 2003

(51) Int. Cl. A23B 4/00

(52) U.S. Cl. 426/108

(57) ABSTRACT

Described are multilayer packaging materials and packaged dough products comprising a dough composition in multilayer flexible package materials, the multilayer materials comprising a sealant layer, a scavenger layer, and a barrier layer.

### FIELD OF THE INVENTION

The invention relates to multi-layer packaging materials that include a carbon dioxide/oxygen scavenger and a sealant layer. The invention further contemplates the food products that include the multi-layer packaging material, as well as the methods for producing such packaging.

### BACKGROUND

Food packaging materials may be prepared from many known materials such as polymeric or other film materials, other plastics and foams, and fibrous materials such as paper and cardboard. Different combinations of these and other packaging materials can be used in countless varieties of package configurations, often in combinations selected to meet particular needs for a class or type of food product.

On occasion, certain types of separate, reactive or non-reactive (inert), chemical components or atmospheres or water-absorbing (hygroscopic) agents may be included in a packaged food product to improve the preserving effect of food packaging. As an example, certain classes of food products may benefit from the use of carbon dioxide scavenger within a package. Carbon dioxide scavengers can remove gaseous carbon dioxide from an interior of a packaged food product, so these scavengers are typically used to package a food product that produces or evolves carbon dioxide during storage. When a food item produces or evolves carbon dioxide during storage, while placed in a substantially air tight package, the carbon dioxide builds and increases the pressure within the package, often causing a flexible package to expand and give the package an abnormal shape or appearance that might prevent a consumer from purchasing or using the packaged food product. Examples of food products that produce or evolve carbon dioxide include dough products, coffee, fresh fruits, meats, cheeses and vegetables.

Unproofed (i.e., unleavened) dough compositions in particular, whether designed to leaven by effects of yeast prior to baking or by effects of chemical leavening agents during or prior to baking, can evolve carbon dioxide even during storage at frozen or refrigerated temperatures. Many such dough compositions are conveniently and economically packaged in substantially air tight packaging for refrigerated or frozen storage. When packaged in substantially air tight packaging, carbon dioxide produced within or evolved from the dough composition, either by action of yeast or chemical leavening agents, can build inside the interior space of the packaging and cause a flexible package to bulge.

Different methods have been attempted and discussed to solve the problem of carbon dioxide buildup in a packaged food product, where the food item evolves carbon dioxide inside its package. Placing carbon dioxide scavenger inside of a packaged food product is an example of one such method. Another example is the use of a one-way gas release valve to release gas buildup inside of a food package.

Another example specific to unproofed chemically-leavened dough products is to attempt to prevent premature reaction of chemical leavening agents by their encapsulation, thereby preventing carbon dioxide production during storage. By this method, premature reaction of chemical leavening agents may be reduced or minimized, but it may not be possible or preferable to completely prevent exposing a chemical leavening agent to a dough composition during storage, or to completely prevent premature reaction of chemical leavening agents.

There is continuing need for food packaging materials and methods for their preparation and use that reduce carbon dioxide within a food product package, especially to reduce or eliminate bulging of a flexible food package.

### SUMMARY

The invention uses multi-layer packaging materials that contain carbon dioxide scavenger. The multi-layer packaging materials include a scavenger layer, sealant layer, a carbon dioxide/oxygen barrier and an optional fibrous layer.

The scavenger layer includes a carbon dioxide scavenger that reacts with carbon dioxide, or with water and carbon dioxide. When present in a food package, the scavenger can reduce the amount of carbon dioxide that builds up inside of the package upon evolution of carbon dioxide from a packaged food item (e.g., coffee, unproofed dough compositions, fresh fruits and vegetables, meats, cheeses, etc.). Carbon dioxide scavenger can absorb amounts of carbon dioxide released by a food item during storage and thereby prevent pressure buildup within a package, or bulging of a flexible package, due to carbon dioxide buildup.

The carbon dioxide scavenger can be included as or in a layer of the multi-layer packaging material, e.g., within a layer of a polymer material. As an example, a scavenger can be included as a filler or a suspended material in a polymeric matrix. That is, a layer of scavenging material can be disposed in a multi-layer packaging material. Polymer materials that form a portion of the packaging in contact with the food product or that contain a carbon dioxide scavenger, can be sufficiently permeable to carbon dioxide to allow carbon dioxide to pass through the polymer and reach the scavenger, to react with the scavenger.

The sealant layer can preferably be at a surface of the multi-layer packaging material and also adjacent to the scavenger layer, so that the sealant layer can be located at the interior of a packaged food product, preferably adjacent to the food product. The sealant layer can be at least partially permeable to carbon dioxide so that carbon dioxide is able to reach the scavenger layer. Transmission of carbon dioxide through the sealant layer and the polymer of the scavenger layer allows carbon dioxide to reach the scavenger material within the scavenger layer and react with the scavenger material, whereby the gaseous carbon dioxide is removed from the interior of the packaging. The sealant layer preferably does not contain carbon dioxide scavenger, and therefore can provide a layer of separation between the scavenger layer and a food product contained by the packaging material. The separation provided by the sealant layer prevents the food product from contacting the scavenger material, which is generally a metal oxide or a metal hydroxide, and which may therefore affect properties of a food product such as taste if allowed to contact the food product. At the same time, the sealant layer, being at least somewhat permeable to carbon dioxide, does not prevent carbon dioxide from reaching the scavenger layer.

The sealant layer also functions as a thermoplastic material that can be used to provide the packaging material with a substantially air tight seal. Again, the sealant layer can preferably exclude carbon dioxide scavenger, to prevent a food product from contacting scavenger. Excluding scavenger from a sealant layer also improves a seal produced by the sealant layer. Scavenger in a sealant layer may interfere with the ability of a polymer of a sealant layer to form a seal, or may detrimentally affect the long-term stability of the seal. Thus, it is again advantageous to use a sealant layer that contains no carbon dioxide scavenger material at the interior surface of the package where the layer may contact food product, to prevent contact of the food with the scavenger material as mentioned, but furthermore to produce an improved seal that can be better formed and more stable due to the absence of carbon dioxide scavenger.

The multi-layer packaging material may also include a fiber or fibrous layer, to produce a paper-like texture or paper-like mechanical properties. Preferred fibrous layers can be of lightweight paper, cardboard or other cellulosic based material.

The multi-layer packaging material may also include other layers for various purposes such as mechanical properties, strength, tear resistance, or for additional barrier properties, e.g., to prevent passage of gases such as oxygen or water vapor into or out of the packaged food product or to prevent carbon dioxide from the atmosphere from contacting and reacting with and depleting the scavenger. Examples may include a polymeric layer for added strength or as an oxygen barrier, e.g., a nylon, polyester, polyvinyldichloride or polyolefin layer.

Certain embodiments of the multi-layer packaging material can be relatively flexible, e.g., if made from materials such as flexible polymers or lightweight paper or cardboard. More or less rigid or flexible multi-layer materials can be prepared according to the invention, although relatively flexible materials are often preferred for packaging many types of food items such as coffee or dough compositions.

In one embodiment of the invention a packaged food item can be a raw dough composition, preferably a refrigerator or freezer stable dough composition, e.g., a chemically-leavenable (i.e., “chemically-leavened”) dough composition. A “chemically-leavened” dough composition means that the dough composition becomes leavened due to a leavening gas (e.g., carbon dioxide) produced by a reaction between chemical leavening agents, typically an acid and a base. Amounts of carbon dioxide evolved by refrigerator stable, chemically leavenable dough compositions, can be absorbed by carbon dioxide scavenger to reduce or substantially prevent package bulging. Preferred carbon dioxide scavengers include metal oxides and metal hydroxide materials.

The chemically-leavenable dough composition may be pre-proofed or unproofed. Certain embodiments of the invention contemplate packaged unproofed, chemically-leavenable dough compositions that are refrigerator stable, evolving relatively low amounts of carbon dioxide during refrigerated storage, e.g., chemically-leavenable dough compositions that evolve less than approximately 70 cubic centimeters (cc) of carbon dioxide per 126 grams (g) of dough composition over 12 weeks at refrigerated storage temperature (e.g., 45 degrees Fahrenheit), preferably less than 50 cc or 40 cc of carbon dioxide per 126 g of dough over 12 weeks at 45 degrees Fahrenheit.

In these and other embodiments of the invention, an amount of carbon dioxide scavenger needed to react with enough evolved carbon dioxide to prevent package bulging can be included in the scavenger layer of the multi-layer packaging material. Not all of the carbon dioxide evolved from a food item needs to be absorbed, but preferably enough carbon dioxide can be absorbed to prevent bulging or substantial pressure buildup of carbon dioxide inside of the package.

As another advantage of packaged dough products of the invention, use of low pressure packaging (e.g., a package having an internal pressure below 10 psig) can make it easier to package fewer portions of a dough composition, e.g., biscuits, per container, which can add an element of portion control to preferred packaged dough compositions of the invention. “Psig” stands for gauge pressure in pounds per square inch—gauge pressure is absolute pressure minus atmospheric pressure; thus, a package having an absolute internal pressure of about 1 atmosphere has an internal gauge pressure of about 0 psig.

As an example, a packaged dough product may include multiple portions of (“portion controlled”) dough compositions packaged in a number of sub-divided units, e.g., a number of packages of 1, 2, or 3 portions (e.g., biscuits), packaged to be substantially air tight, but still not pressurized, and packaged according to the invention in a film or paper-like multi-layer packaging material that contains a carbon dioxide scavenger to reduce or prevent bulging of the individual sub-divided packages. More than one of the sub-divided packaged units containing 1 or more dough portions (e.g., biscuits, rolls) can be included in a larger, non-pressurized package. According to the invention, multiple sub-divided packages of dough compositions can be packaged to include one or more dough composition in a multi-layer packaging material as described herein. Those packaged portions can be included in a larger package, e.g., a bag or a cardboard box, and each of the sub-divided packages can be removed, opened, and used separately. The other sub-divided portions remain packaged for later use.

In an exemplary embodiment of the present invention, a multi-layer packaging material is described and includes, a carbon dioxide/oxygen barrier layer, a sealant layer at least partially permeable to carbon dioxide, and a scavenger layer. The scavenger layer can include a polymer and carbon dioxide scavenger, with the scavenger layer located between the sealant layer and the carbon dioxide/oxygen barrier layer.

In a further exemplary embodiment of the present invention, a method of preparing a multi-layer packaging material is described and includes the steps of initially providing a laminate that includes a carbon dioxide/oxygen barrier layer, a sealant layer at least partially permeable to carbon dioxide, and a scavenger layer. The scavenger layer includes a polymeric matrix that has a carbon dioxide scavenger, and the scavenger layer is located between the sealant layer and the oxygen barrier layer. The layers, carbon dioxide/oxygen barrier layer, sealant layer, and scavenger layer, are co-extruded.

In a still further embodiment of the present invention, a packaged food product is disclosed and includes a food product packaged in multi-layer packaging material. The packaging material of the present embodiment has a carbon dioxide/oxygen barrier layer, a sealant layer that is at least partially permeable to carbon dioxide at the interior surface of the package, and a scavenger layer. The scavenger layer includes a polymeric matrix that contains a carbon dioxide scavenger located between the sealant layer and the oxygen barrier layer.

In a still further exemplary embodiment of the invention, a method of preparing a packaged dough composition is described and includes the steps of, initially providing a chemically-leavenable dough composition. Then the dough composition is packaged in a package that contains at least a carbon dioxide/oxygen barrier layer, a sealant layer that is at least partially permeable to carbon dioxide, and a scavenger layer. The scavenger layer includes a polymeric matrix that contains a carbon dioxide scavenger, and the scavenger layer is located between the sealant layer and the oxygen barrier layer.

As used with respect to the present description and unproofed dough compositions, the term “refrigeration-stable” means that an unproofed dough composition undergoes sufficiently little leavening during refrigerated storage to be a useful commercial or consumer dough product, e.g., there is not an excessive amount of leavening gas (e.g., carbon dioxide) production during refrigerated storage. For example, the raw specific volume (RSV) remains at an acceptable level, such as from 0.9 to 1.6 cc/gram, or, the dough composition evolves less than approximately 70 cubic centimeters (cc) of carbon dioxide per 126 grams (g) of dough composition over 12 weeks at refrigerated storage temperature (e.g., 45 degrees Fahrenheit), preferably less than 50 cc or 40 cc of carbon dioxide per 126 g of dough over 12 weeks at 45 degrees Fahrenheit.

The term “unproofed” refers to a dough composition that has not been processed to include any step intended to cause proofing or intentional leavening of a dough composition. For example, a dough composition may not have been subjected to a specific holding stage for causing the volume of the dough to increase by 10% or more. The raw specific volume (RSV) of an unproofed dough composition can typically be in the range from about 0.9 to about 1.6 cubic centimeters per gram.

### BRIEF DESCRIPTION OF THE DRAWINGS

FIGS. 1 and 2 illustrate side views of embodiments of multi-layer flexible packaging materials that include a carbon dioxide scavenger layer, a sealant layer, and an optional fibrous layer; and

FIG. 3 illustrates a cut away view of an embodiment of a packaged dough product that contains multiple packaged portions of dough composition, each contained in flexible packaging material, and each package including carbon dioxide scavenger, with all of the packaged portions being contained in a larger package for individual sale.

### DETAILED DESCRIPTION

According to the invention, carbon dioxide scavenger is included in a multi-layer packaging material especially useful for packaging food products. The packaging material also includes a carbon dioxide/oxygen barrier layer to prevent depletion of the scavenger from the surrounding atmosphere and protection of the food from oxidation. The packaging material may optionally include a fibrous layer.

The packaging material also includes a sealant layer that is placed or positioned at the interior of a packaged food product where the sealant layer may contact the food product. The packaging material should preferably be flexible. The flexible packaging film includes multiple layers, including a sealant layer, a scavenger layer, carbon dioxide/oxygen barrier layer. An optional fibrous layer may be included. Examples of materials useful for producing packaging materials containing carbon dioxide scavenger are described in Assignee's copending U.S. patent application Ser. No. 10/273,668, filed Oct. 16, 2002, entitled “Dough Composition Packaged in Flexible Packaging with Carbon Dioxide Scavenger,” the entire disclosure of which is incorporated herein by reference.

The sealant layer is at a surface of the multi-layer film. At the surface, the sealant layer can be placed at the interior of a package that contains a food product. The sealant layer can prevent food from contacting the scavenger layer, and thereby prevent possible contamination of the food by the scavenger, which may negatively affect taste or other properties of the food product.

For this reason, preferred sealant layers do not contain carbon dioxide scavenger, but can provide a layer of separation between the scavenger layer and a food product contained by and in contact with the packaging material. The sealant layer may be especially useful when the packaging material contains a food product that includes a liquid or aqueous component, such as a dough composition, because a liquid or water may pull the scavenger into the dough, as opposed to a more dry food product such as coffee.

The sealant layer can preferably be adjacent to the scavenger layer. The sealant layer can be at least partially permeable to carbon dioxide so that carbon dioxide is able to reach the scavenger layer and the scavenger material. The rate of carbon dioxide transmission through the sealant layer and the polymer of the scavenger layer allows carbon dioxide to pass through the sealant layer and the polymer of the scavenger layer, to reach the scavenger material within the scavenger layer and react with the scavenger material, whereupon the carbon dioxide becomes removed from the interior of the packaging.

The sealant layer is sufficiently permeable to carbon dioxide to allow carbon dioxide to reach the scavenger layer where the carbon dioxide can be reacted with the carbon dioxide scavenger. Another function of the sealant layer can be to provide an air-tight and durable seal for the package. The sealant layer therefore can preferably be a layer that can be heat processed to produce such a seal. Examples of materials that can be at least partially permeable to carbon dioxide and also can be used to produce an air tight and durable seal include thermoplastic polymer materials such as polyolefins.

A sealant layer is typically the interior layer and inner surface of the multi-layer packaging material and when folded to place two sealant layers into contact, can be used to seal a package of the multi-layer material with time, elevated temperature, and pressure, to melt the sealant layer and form a sealed packaged product (e.g., a pouch or a bag, etc.). A sealant layer can be a low temperature melt point polymer used to seal a package closed. Examples of useful materials for a sealant layer include polyolefins such as LLDPE (linear low density polyethylene), LDPE (low density polyethylene), or copolymers of polyolefin or polyethylene with other monomers such as EVA (ethylene vinyl acetate).

The scavenger layer includes carbon dioxide scavenger (or simply “scavenger”). The carbon dioxide scavenger may be a separate layer by itself or may be contained in a layer of the multi-layer film. A scavenger material can preferably be included as a filler or a suspended material in a polymeric matrix that is a layer of a multi-layer packaging material. See, for example, U.S. Pat. No. 6,451,432, which describes flexible films that contain carbon dioxide scavenger materials, the disclosure of which is incorporated by reference. According to the present invention, the polymer can be a polymer that can produce a useful layer of polymer and scavenger, and that is sufficiently permeable to carbon dioxide to allow carbon dioxide to pass into the polymeric material to contact the scavenger material contained therein. Examples can include polyolefins such as LDPE and LLDPE copolymers of polyolefin (e.g., polyethylene) with other monomers such as ethylene vinyl acetate, etc.

Useful scavengers can include metal oxides and metal hydroxides. A metal oxide can react with water to produce a metal hydroxide. The metal hydroxide can react with carbon dioxide to form water and a metal carbonate.

As an example, if the scavenger contains calcium oxide, water (present in the packaging from the dough composition) reacts with the calcium oxide to produce calcium hydroxide:

CaO+H₂O→Ca(OH)₂

Thereafter the calcium hydroxide reacts with carbon dioxide evolved from the dough composition to yield calcium carbonate and water:

Ca(OH)₂+CO₂→CaCO₃+H₂O

While calcium oxide and calcium hydroxide can be preferred as the carbon dioxide scavenger, other metal oxides and metal hydroxides such as magnesium oxide and barium oxide may also be used. The reactions with magnesium and barium are analogous to those with calcium, as indicated above. Alternatively, potassium oxide (K₂O) and sodium oxide (Na₂O) can be used. The reactions are analogous to those for calcium oxide, as shown above. The reactions are:

Na₂O+H₂O→2Na(OH)

or

K₂O+H₂O→2K(OH)

Thereafter the hydroxides combine with CO₂ as follows:

2NaOH+CO₂→Na₂CO₃+H₂O

or

2KOH+CO₂→K₂CO₃+H₂O.

A useful carbon dioxide scavenger layer or packaging material or package may or may not include other components that might prevent or reduce package bulging, in addition to the scavenger. Some previous carbon dioxide scavengers have been used in combination with moisture producing or moisture retaining agents, hydrating agents, desiccants, hygroscopic agents, anhydrous materials, etc., (see, e.g., EP 0176371 B1 and U.S. Pat. Nos. 5,322,701 and 6,451,423 B1). These moisture producing or moisture retaining agents can be useful according to the invention, to provide moisture for hydrating a metal oxide to form a hydroxide that reacts with carbon dioxide, especially in the absence of water within the packaged food item or the packaged food product. Certain preferred embodiments of packaged food products of the invention, however, can include sufficient water to avoid the need for a separate added moisture producing or moisture retaining agent. (These food products include raw dough compositions.) As such, any of these moisture producing or moisture retaining agents may be used in the scavenger layer or another layer of the packaging material of the invention, but may not be necessary and may preferably be excluded from the packaging material and the packaged food product.

Preferred scavenger layers used in accordance with the invention, especially to package a raw dough product, may contain no added hygroscopic agent, desiccant, anhydrous material, hydrating agent, or other moisture producing or moisture retaining agents, and may consist of or consist essentially of polymer and scavenger. This can be particularly true if a packaging material is used in to package a food item that contains a substantial water component, such as a raw dough composition, which contains a water component that can hydrate the metal oxide to allow reaction with carbon dioxide. This eliminates the need for water retaining or water producing agents, and such embodiments of packaging materials and packaged dough products of the invention may include no added moisture producing or moisture retaining agents to prevent package bulging other than the conventional dough ingredients and dough packaging materials.

The scavenger can be present in a scavenger layer in an amount sufficient to contact and react with an amount of carbon dioxide that during storage evolves from the dough composition. Preferably, an amount of scavenger can be included in the scavenger layer that is sufficient to react with an amount of evolved carbon dioxide to reduce and preferably prevent substantial package bulge. In terms of internal package pressure, a preferred pressure to reduce bulging can be less than 10 psig, preferably less than 5 psig or less than 1 psig. The amount of scavenger needed will depend on various factors such as the type of scavenger, the type of dough composition, the amount of dough composition contained in a package, the size (volume) of the package, and the amount of carbon dioxide that evolves from the dough composition, etc. Generally, a useful amount of scavenger available in a scavenger layer can be an amount stoichiometrically calculated to sequester at least a portion of an amount of carbon dioxide expected to evolve from a packaged dough product. It is not necessary that the entire amount of carbon dioxide evolved from a dough composition be reacted, but only enough so that the remaining amount of unreacted carbon dioxide does not cause substantial packaging bulge. When the scavenger is calcium oxide, a stoichiometric amount of calcium oxide to sequester 70 cc of carbon dioxide can be approximately 0.168 grams. Exemplary amounts of scavenger (e.g., calcium oxide) in a packaged dough product can be in the range from 0.05 or 0.10 to 0.50 grams scavenger per 126 grams dough composition, e.g., from 0.15 to 0.35 grams scavenger per 126 grams dough composition. As an example of an amount of scavenger per weight of a packaging film, calcium oxide or calcium hydroxide can be present at up to 40% by weight of a scavenger layer.

The multi-layer packaging material may also include other materials, e.g., as layers or portions of a layer, for various purposes such as mechanical properties, strength, tear resistance, barrier properties, i.e., to prevent passage of gases such as oxygen or water vapor into the packaged food product or atmospheric carbon dioxide from depleting the scavenger. Examples may include a polymeric layer for strength or as an oxygen barrier, e.g., a nylon, polyester, polyvinyldichloride, ethylene vinyl alcohol (EVOH), polyolefin, or combinations thereof.

The multi-layer packaging film may also include a fibrous layer, to provide paper-like qualities. The fibrous layer may be cardboard or paper, and may be treated, bleached, colored, printed, or otherwise processed to accommodate a certain type of food product. The fibrous layer can provide paper-like mechanical properties such as strength, rigidity, tear, or modulus, as desired, as well as paper-like texture, color, printability, etc. Examples of useful fibrous layers can be lightweight paper or cardboard that allow for one or more paper-like properties of flexibility, strength, tearability, texture, printability, etc.

Certain embodiments of the described multi-layer food packaging material can be relatively flexible, e.g., if made from flexible polymers or lightweight paper or cardboard. More or less rigid or flexible multi-layer materials can be prepared according to the invention, although relatively flexible materials are often preferred for packaging many type of food items such as coffee or dough compositions.

According to the invention, the dough composition is preferably packaged in a low pressure container, meaning that the packaging is substantially air tight (it will bulge if a gas such as carbon dioxide builds inside the packaging) but otherwise does not create a pressurized interior space. An internal pressure can be less than 15 psig, preferably less than 10 psig or less than 5 or 1 psig. The packaging material may include but does not require and preferably excludes a pressure relief valve.

The thickness of individual layers of the multi-layer packaging film can be sufficient to perform the intended function of the layer, such as to function as a support layer, as an oxygen barrier layer, as a scavenger layer, or as a sealant layer, respectively. The overall thickness of the multi-layer film can be preferably be sufficient to provide flexibility and useful processing properties.

A multi-layer packaging material as described herein can be produced by methods that will be understood by those of skill in the packaging materials arts. Useful techniques may include known methods of extrusion and lamination. A preferred method of preparing a multi-layer film may be to co-extrude polymeric layers. The multi-layer co-extruded film can be laminated to an optional fibrous layer, either by first cooling and subsequent lamination, or by extrusion onto the fibrous layer.

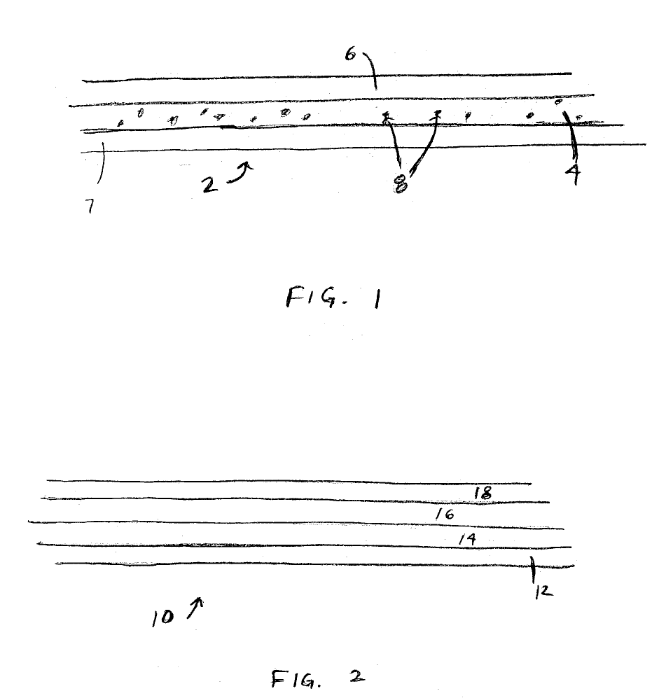

FIG. 1 illustrates an example of a multi-layer flexible packaging material (film) according to the invention. Film 2 includes multiple layers (three layers as illustrated). Layer 4 is a scavenger layer that includes a polymeric layer that contains particles 8 of suspended carbon dioxide scavenger. Layer 6 is a barrier layer. Layer 6 can include a barrier material, e.g., a polymeric material that prevents passage of liquid or gaseous materials such as liquid or gaseous moisture or gaseous carbon dioxide or oxygen. Layer 7 is a polymeric sealant layer that is permeable to carbon dioxide and that is able to be melted to form a seal when folded against itself. As illustrated, layer 7 does not include carbon dioxide scavenger. Scavenger layer 4 is adjacent to the sealant layer 7 so that scavenger is available to contact carbon dioxide evolved from a dough composition—i.e., carbon dioxide can pass through sealant layer 7 and into scavenger layer 4, to contact and react with scavenger 8. Barrier layer 6 will be at or toward the exterior of the packaged dough product compared to scavenger layer 4 and sealant layer 7. The multi-layer flexible packaging film 2 of FIG. 1 is illustrated as having three layers, but more layers can be useful as well. Other polymeric layers, for example, placed in useful arrangement compared to the scavenger layer and sealant layer, may be useful for selected functions, such as to provide desired mechanical properties. Additionally, printing or graphics may be added to a layer of the packaging material, e.g., applied to a fibrous layer.

FIG. 2 illustrates another embodiment of a useful multi-layer film. FIG. 2 shows film 10 that includes a sealant layer 12 (to be place at an interior of a packaged dough composition), scavenger layer 14, carbon dioxide/oxygen barrier layer 16, and fibrous layer 18. Sealant layer 12 is at least partially permeable to carbon dioxide, so carbon dioxide can reach scavenger layer 14. Printing or graphics may be added to fibrous layer 18.

As in all of the figures of the present description, the sizes of layers shown in FIGS. 1 and 2 are not drawn to scale.

The packaging material may be used with any type of food product, and will be particularly useful to produce a substantially air-tight packages such as pouches or bags for containing food products that evolve carbon dioxide during storage, such as dough compositions, coffee, and the like.

The packaging material can be particularly useful with food compositions that contain an aqueous component such as raw dough compositions, especially refrigerator stable chemically-leavenable raw dough compositions. Generally, the dough composition can be any dough composition that evolves carbon dioxide during refrigerated or frozen storage. When packaged in flexible packaging and stored at refrigerated or frozen storage conditions, yeast-leavened and chemically-leavened dough compositions can produce carbon dioxide that can cause an air-tight flexible package to bulge. According to the invention, a packaged dough product can be packaged in a multi-layer flexible packaging material that contains carbon dioxide scavenger that can react with the carbon dioxide to form a lower volume reaction product, thereby preventing buildup of carbon dioxide gas in the package, and reducing or preventing substantial packaging bulge.

The packaged dough product can include any type or formulation of yeast or chemically-leavenable dough composition that evolves carbon dioxide during refrigerated or frozen storage. These can include pre-proofed or unproofed dough compositions. Many if not all formulations of (pre-proofed or unproofed) yeast and chemically-leavenable dough compositions evolve an amount of carbon dioxide during refrigerated or frozen storage. The invention can be used to avoid bulging of such dough compositions packaged in a substantially air tight flexible plastic packaging by including a carbon dioxide scavenger in the packaged dough product, as described, in combination with a fibrous layer and a sealant layer.

The invention does not require that any particular type or formulation of dough composition be used in combination with the described packaging material. Still, the inventive use of a carbon dioxide scavenger with the inventive packaging, to avoid bulging, has been found to be particularly useful with certain types of chemically-leavenable dough compositions, e.g., based on the type of chemical leavening agents included in the dough composition, and based on a relatively low amount of carbon dioxide evolution from such dough compositions during storage.

Preferred chemically-leavenable dough compositions for use according to the invention can be non-proofed (unproofed) chemically-leavenable dough compositions that include encapsulated basic chemical leavening agent, non-encapsulated acidic chemical leavening agent, and that because of this combination of chemical leavening agents exhibit a relatively low amount of carbon dioxide evolution during refrigerated storage.

Chemically-leavened dough compositions can be prepared from ingredients generally known in the dough and bread-making arts, typically including flour, a liquid component such as oil or water, a chemical leavening system, and optionally additional ingredients such as shortening, salt, sweeteners, dairy products, egg products, processing aids, emulsifiers, particulates, dough conditioners, yeast as a flavorant, flavorings, and the like.

A preferred chemical leavening system for non-preproofed dough compositions can include a basic chemical leavening agent and an acidic chemical leavening agent, the two of which react to produce carbon dioxide, desirably during baking, to leaven the dough composition during baking. Amounts of the chemical leavening agents can become exposed to each other and react prior to baking, e.g., during refrigerated storage. This premature reaction can be reduced by selecting chemical leavening agents that are of low solubility in the aqueous portion of the dough composition at storage temperature, or by encapsulating one or more of the chemical leavening agents in a material that is solid at storage temperature but that melts or degrades at baking temperature. Certain non-preproofed dough compositions for use in accordance with the invention include encapsulated basic chemical leavening agent and non-encapsulated, preferably low solubility, acidic chemical leavening agent.

Acidic chemical leavening agents are generally known in the dough and bread-making arts, and include sodium aluminum phosphate (SALP), sodium acid pyrophosphate (SAPP), and monosodium phosphate; monocalcium phosphate monohydrate (MCP), anhydrous monocalcium phosphate (AMCP), dicalcium phosphate dihydrate (DCPD) as well as a variety of others. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP). These and other examples of acidic chemical leavening agents useful in the compositions are described in Assignee's copending U.S. patent application Ser. No. 09/945,204, filed Aug. 31, 2001, entitled “Chemically Leavened Doughs and Related Methods,” and in U.S. Pat. No. 6,261,613, the entire disclosures of which are incorporated hereby by reference.

Preferred non-encapsulated acidic agents for non-preproofed dough compositions can include those that are slightly soluble in an aqueous phase of a dough composition at processing and refrigeration temperatures. The acidic agent can react with the basic agent only after the acidic agent dissolves in the aqueous phase of a dough composition, so a low solubility prevents reaction of the agents during processing and storage. A higher solubility of the acidic agent is desired at baking temperatures, to allow dissolution and reaction with the basic agent to leaven the dough during baking. Especially preferred acidic chemical leavening agents exhibit slight solubility at processing or refrigerated storage temperatures (e.g. from about 40 to about 55 degrees Fahrenheit) and therefore remain substantially solid during refrigerated storage, up until baking. At higher temperatures (e.g., a temperature that occurs at an early stage of baking, such as a temperature in the range form 100° F. to 200° F., or a temperature at a later stage of baking, such as 300F. to 350F.), preferred acidic agents become substantially soluble.

Particularly useful acidic chemical leavening agents include SALP and SAPP and those that exhibit solubility behaviors similar to SALP and SAPP (most preferably SALP). SALP and SAPP exhibit low solubilities at comparatively low temperature ranges, such as below about 35-40° C.; however, they have adequate solubilities at higher (e.g., baking) temperatures.

The amount of acidic chemical leavening agent included in a dough composition can be an amount sufficient to neutralize an amount of basic chemical leavening agent during baking, e.g., an amount that is stoichiometric to the amount of basic chemical leavening agent, with the exact amount being dependent on the particular acidic chemical leavening agents that is chosen. A typical amount of acidic agent such as SALP may be in the range from about 0.25 to about 2 parts by weight per 100 parts dough composition, with ranges from about 0.25 to about 1.5 parts by weight per 100 parts dough composition being preferred.

Preferred dough compositions of the invention can include encapsulated basic chemical leavening agent. Discussions of encapsulated basic agents are included in Assignee's copending U.S. patent application Ser. No. 09/945,204, “Chemically Leavened Doughs and Related Methods,” and U.S. Pat. No. 6,261,613.

The terms “encapsulated basic chemical leavening agent,” “encapsulated basic agent,” or simply “encapsulated particles,” refer to particles that include solid basic chemical leavening agent particulates covered in part, e.g., substantially completely, by barrier material. Encapsulated particles are known in the baking arts, and include encapsulated particles sometimes referred to as “enrobed” particles, as well as those sometimes referred to as “agglomerated” particles. The barrier material forms a coating or shell around a single or multiple particulates of solid chemical leavening agent, separating the chemical leavening agent from a bulk dough composition. “Enrobed” particles generally include a single particulate of chemical leavening agent covered or coated by barrier material, and “agglomerate” particles generally include 2, 3, or more particulates of chemical leavening agent contained in a mass of barrier material.

Encapsulating the basic chemical leavening agent provides separation between the basic agent and the dough composition to inhibit or prevent reaction of basic and acidic agents until a desired time or condition of processing or use, at which condition the barrier material or encapsulated material degrades and exposes the base to the dough composition.

Useful basic chemical leavening agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic chemical leavening agent are generally soluble in an aqueous phase of a dough composition at processing or refrigerated storage temperature.

Encapsulated particles containing basic chemical leavening agent and barrier material are generally known, and can be prepared by methods known in the baking and encapsulation arts. An example of a method for producing enrobed particles is the use of a fluidized bed.

The amount of a basic chemical leavening agent to be used in a dough composition is preferably sufficient to react with the included acidic chemical leavening agent to release a desired amount of gas for leavening, thereby causing a desired degree of expansion of the dough product. Exemplary amounts of a basic chemical leavening agent (not including the weight of a barrier material) may be in the range from about 0.25 to about 2 parts by weight per 100 parts dough composition, with ranges from about 0.75 to about 1.5 parts by weight 100 parts dough composition being preferred.

Examples of packaged dough products useful according to the invention can include any amount of dough composition, and preferably, the volume of the packaging material is of the same order as the volume of the packaged dough composition. In terms of headspace (volume inside the package that is not taken up by dough composition) for an exemplary non-preproofed packaged dough product, the packaged dough product can contain from about 54 to about 184 cubic centimeters head space per 126 grams of dough composition, preferably from about 54 to about 94 cubic centimeters headspace per 126 grams dough composition. To avoid substantial packaging bulge, it is desirable that the amount of carbon dioxide evolved by the dough composition, and not reacted by the scavenger, is less than the amount of headspace. Generally if there is less than 30 cubic centimeters of carbon dioxide not reacted with scavenger (per 126 grams dough) (e.g., for a package design in the form of a pouch approximately 3¾″×7¾″ with headspace as described above) then the packaged dough product does not experience a substantial amount of packaging bulge (assuming a flat, side-by-side biscuit product arrangement). Volume of evolved carbon dioxide can be determined by measuring package headspace volume (through water displacement of package and product minus the product volume) and measuring the percent carbon dioxide of the headspace gas (e.g., with an instrument such as a dansensor).

A particular embodiment of packaged dough product according to the invention can involve a packaged dough product that contains sub-divided packages containing one or multiple portions of dough composition packaged separately with a flexible packaging material as described, wherein the sub-packages are themselves contained together within a larger package to make up the packaged dough product. The sub-divided dough packages use low pressure packaging as described herein, which can make it easier (e.g., as opposed to pressurized cans often used with refrigerated dough products) to package fewer portions of dough composition, e.g., biscuits, in a single package, which in turn allows the advantage of portion control, i.e., less than all portions contained in a packaged dough product may be used together upon opening the packaged dough product.

As an example, a packaged dough product may include one or multiple portions of dough compositions packaged in a number of sub-divided units, e.g., a packaged dough product may contain multiple smaller packages of 1, 2, or 3 portions of dough composition, with each smaller package being substantially air tight but still not pressurized and comprising a multi-layer packaging material described herein. The smaller packaged dough product may contain 1, 2, 3, or any other number of dough portions such as a biscuit, as would be convenient for a consumer to use at one time. This number of dough composition portions can be packaged with flexible packaging as described, including a carbon dioxide scavenger to reduce or prevent bulging of the individual 1 or 2 or 3 portion package. More than one of the smaller packaged units containing 1 or multiple dough composition portions can be included in a larger, non-pressurized package.

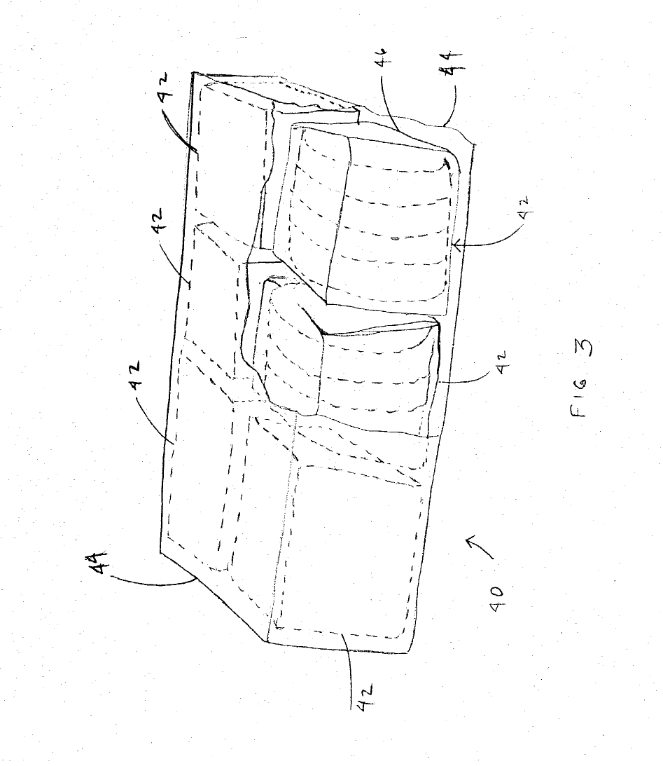

FIG. 3 illustrates an example of a packaged dough product of the invention that can be marketed for individual sale, and that contains sub-divided packaged dough products for separate use. Packaged dough product 40 includes six sub-units 42 of packaged dough products inside of larger package 44. The number of sub-units within the larger packaging 44 can vary as desired, and may be 2, 4, 8, 10, or any other number. While the sub-units 42 are shown to be placed into packaging 44 without support or dividers, a divider may be used to maintain separation between the sub-units 42. Any type of divider may be useful, such as a plastic tray or cardboard inserts. Each sub-unit 42 as illustrated contains 4 portions of a dough composition (e.g., a biscuit). The sub-units may contain more or fewer, depending on factors such as the type of dough composition and convenience. Also, the illustrated biscuits are stacked horizontally but may be arranged in any configuration, e.g., side-by-side. The sub-units are packaged in a multi-layer flexible film packaging 46, that includes a scavenger layer, a sealant layer, and a barrier layer. Packaging 44 may be of any useful material such as a rigid cardboard, plastic, or a non-rigid plastic film or paper. Package 44 or its packaging material does not need to contain carbon dioxide scavenger other than the amount of scavenger contained in packages of the sub-units 42.

It will thus be seen according to the present invention a highly advantageous packaging material has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A multi-layer packaging material for dough, comprising
a carbon dioxide/oxygen barrier layer,
a sealant layer at least partially permeable to carbon dioxide, and
a scavenger layer comprising a polymer and carbon dioxide scavenger, the scavenger layer located between the sealant layer and the oxygen barrier.

2. The packaging material of claim 1, wherein the scavenger layer comprises polyolefin and carbon dioxide scavenger.

3. The packaging material of claim 2, wherein the carbon dioxide scavenger comprises a metal oxide or a metal hydroxide.

4. The packaging material of claim 1, wherein the carbon dioxide scavenger comprises calcium oxide.

5. The packaging material of claim 1, wherein the carbon dioxide/oxygen barrier, the scavenger layer, and the sealant layer are co-extruded.

6. The packaging material of claim 1, wherein the oxygen barrier layer comprises polymer selected from the group consisting of a nylon, polyvinyldichloride, an ethylene vinyl alcohol, a polyester, and combinations thereof.

7. The packaging material of claim 1, wherein the scavenger layer comprises carbon dioxide scavenger and polymer selected from the group consisting of a polyolefin, a polyalcohol, and combinations thereof.

8. The packaging material of claim 1, wherein the sealant layer comprises polyolefin and does not contain carbon dioxide scavenger.

9. The packaging material of claim 8, wherein the sealant layer comprises polyethylene.

10. The packaging material of claim 9, wherein the sealant layer comprises polymer selected from the group consisting of linear low-density polyethylene, low density polyethylene, polyethylene vinyl acetate, polyethylene vinyl acetate-ethylene copolymer, and combinations thereof.

11. The packaging material of claim 1, comprising a fibrous layer selected from the group consisting of paper, paperboard, cardboard, cellulosic based stock, and combinations thereof.

12. A method of preparing a multi-layer packaging material for dough, the method comprising
providing a laminate to be used in forming a packaging material suitable for containing dough based food products, the laminate having a carbon dioxide/oxygen barrier layer, a sealant layer at least partially permeable to carbon dioxide, and a scavenger layer, the scavenger layer including a polymeric matrix containing carbon dioxide scavenger, the scavenger layer located between the sealant layer and the carbon dioxide/oxygen barrier layer; and
co-extruding the carbon dioxide/oxygen barrier, sealant layer, and scavenger layer to form a multiple layer packaging material.

13. The method of claim 12, comprising laminating the co-extruded carbon dioxide/oxygen barrier, sealant layer, and scavenger layer onto a fibrous material.

14. The method of claim 13, wherein the fibrous material is selected from the group including paper, paperboard, cardboard, cellulosic based stock, and combinations thereof.

15. A packaged food product comprising a dough based food product packaged in multi-layer packaging material, the packaging material comprising
carbon dioxide/oxygen barrier layer,
a sealant layer at least partially permeable to carbon dioxide at the interior surface of the package, and
a scavenger layer comprising a polymeric matrix containing carbon dioxide scavenger, the scavenger layer located between the sealant layer and the oxygen barrier layer.

16. The food product of claim 15, wherein the food product is a chemically-leavened dough composition.

17. The dough product of claim 16, wherein the packaging material comprises a co-extruded multi-layer film comprising a polymeric carbon dioxide/oxygen barrier layer, a polyolefin layer comprising carbon dioxide scavenger, and a polyolefin sealant layer.

18. The dough product of claim 16, wherein the carbon dioxide scavenger comprises a metal oxide or a metal hydroxide.

19. The dough product of claim 16, wherein the carbon dioxide scavenger comprises calcium oxide.

20. A method of preparing a packaged dough composition, the method comprising
providing a chemically-leavenable dough composition, and
packaging the dough composition in a package comprising,
carbon dioxide/oxygen barrier layer,
a sealant layer at least partially permeable to carbon dioxide, and
a scavenger layer comprising a polymeric matrix containing carbon dioxide/oxygen scavenger, the scavenger layer located between the sealant layer and the oxygen barrier layer.

21. The method of claim 20 wherein the dough composition is a refrigerator stable, chemically-leavened dough composition.

22. The method of claim 20 wherein the package comprises an unvented heat sealed pouch having an internal pressure below 5 psig (pounds per square inch gauge).
